(19) United States
(12) Patent Application Publication
(10) Pub. No.: US 2007/0222757 A1
(43) Pub. Date: Sep. 27, 2007

(54) Display for statuses of keys on a wireless keyboard

(76) Inventor: Huo-Lu Tsai, Taichung Hsien (TW)

Correspondence Address: G. LINK CO. LTD., 3550 Bell Road, Minooka, IL, 60447, US

(21) Appl. No.: 11/384,666

(22) Filed: Mar. 21, 2006

(51) Int. Cl. G09G 5/00

(52) U.S. Cl. 345/168

(57) ABSTRACT

A display for showing statuses of keys on a wireless keyboard, which provides a key set, a central processing device, a wireless emitter, a battery and an electronic sheet display module in the base thereof. Signals of functional keys are processed by the central processing device to supply driving voltage for an electronic sheet in the electronic sheet display module such that the electronic sheet display module presents color change to show status of the respective functional keys.

### BACKGROUND OF THE INVENTION

1. Field of the Invention

The present invention is related to a display for statuses of keys on a wireless keyboard and particularly to a display, in which electronic sheets are applied to show statuses of keys on a wireless keyboard for saving power consumption.

2. Brief Description of the Related Art

The peripheral of a conventional desktop computer such as the mouse, the keyboard, the writing board or the scanner usually needs a cable to connect with the host unit of the computer in order to perform transmission of signal input. Taking the keyboard as an example, the traditional keyboard requires a transmission cable line for data inputting to the host unit and receiving power supply from the host unit regardless what type of the interface is employed. The conventional keyboard provides three signal lights at the upper right corner for showing input statuses and informing the user the assigned status of the keyboard. For instance, Num Lock light being on means the numeral keys are able to be used normally; Cap Lock light being on means all the alphabet keys being capital letters and Scroll Lock key being on means the scroll of the specific program being locked. The preceding lights are light emitting diodes with green light. However, the conventional keyboard is restricted by the length of the transmission cable line, that is, the keyboard has to be placed in an extent the cable line can reach. Further, it can be understood that it look mess and is not easy to be arranged for integrity in case of the rear side of the host unit is adapted with a lot of transmission cable lines. This is why the wireless keyboard is developed.

Due to message transmitting from the wireless keyboard to the host unit via a wireless interface and the wireless keyboard being unable to receive power from the host unit, an independent power supply, which is a dry battery normally, has to be provided therein while in operation. But, the battery has only limited capacity and it is insufficient for longer time of operation. In order to save power consumption, the LED indicator lights, which keep on lighting and need more power consumption, prior art has removed the LED indicator lights on the wireless keyboard. Usually, users, who are accustomed to the conventional keyboard, are not used to being without the LED indicator lights. Hence, how to remain the indicator lights with less power consumption is a subject worth to care.

### SUMMARY OF THE INVENTION

An object of the present invention is to provide a display for statuses of keys on a wireless keyboard, which remains the conventional display and is capable of saving power consumption.

In order to achieve the preceding object, technique of the electronic sheet is applied to replace the LED for saving the power consumption. Accordingly, a status display for keys on a wireless keyboard according to the present invention provides a key set, a central processing device, a wireless emitter, a battery and an electronic sheet display module in the base thereof. Signals of functional keys are processed by the central processing device to supply driving voltage for an electronic sheet in the electronic sheet display module such that the electronic sheet display module presents color change to show status of the respective functional keys. The electronic sheet employed in the display module provides film shaped structure with memory and power saving.

### BRIEF DESCRIPTION OF THE DRAWINGS

The detail structure, the applied principle, the function and the effectiveness of the present invention can be more fully understood with reference to the following description and accompanying drawings, in which:

FIG. 1 is a fragmentary perspective view illustrating the first embodiment of a display of statuses of keys on a wireless keyboard according to the present invention;

FIG. 2 is a block diagram of a system structure for a display of statuses of keys on a wireless keyboard according to the present invention;

FIG. 3 is a fragmentary perspective view illustrating the second embodiment of a display of statuses of keys on a wireless keyboard according to the present invention; and

FIG. 4 is a fragmentary perspective view illustrating the third embodiment of a display of statuses of keys on a wireless keyboard according to the present invention;

### DETAILED DESCRIPTION OF THE INVENTION

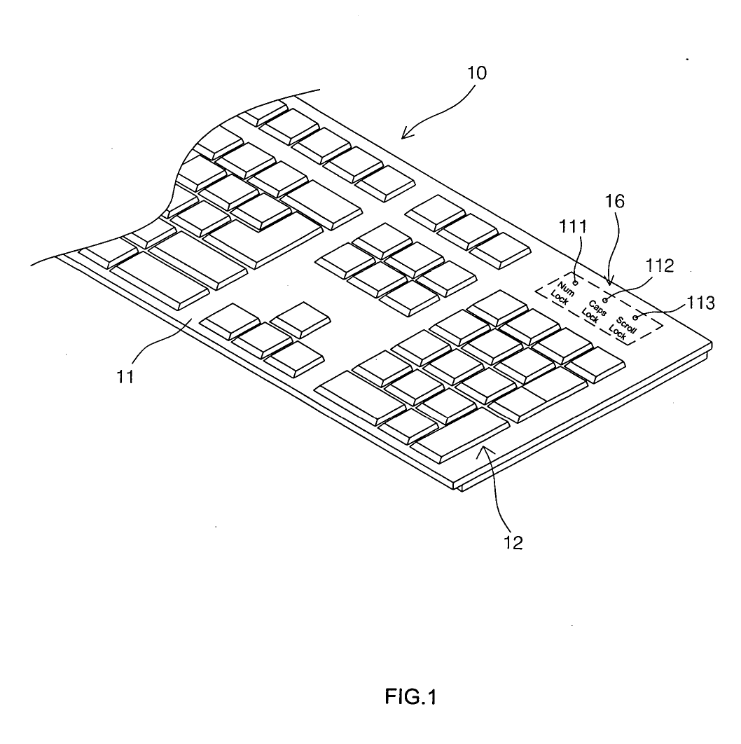

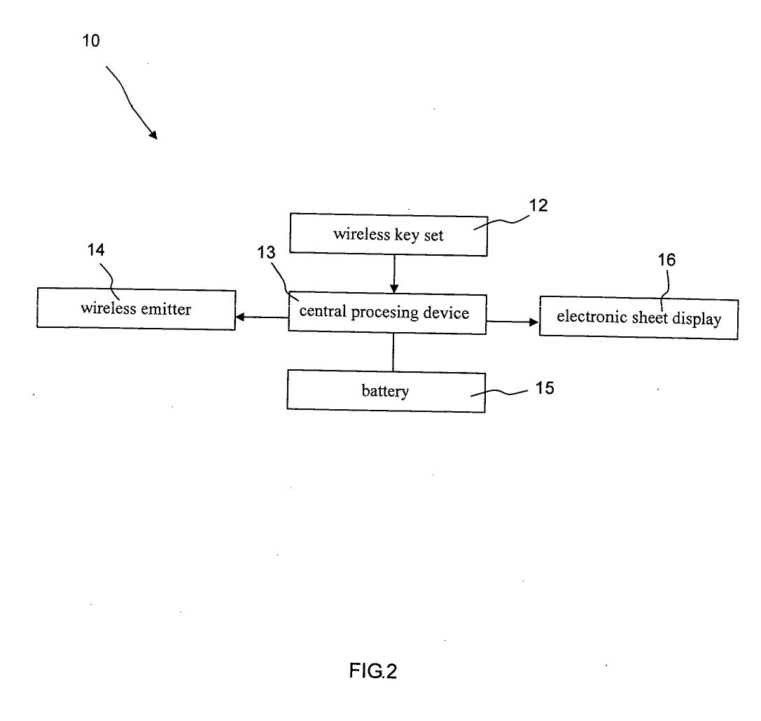

Referring to FIGS. 1 and 2, a display of statuses of keys on a wireless keyboard according to the present invention provides a wireless keyboard 10. The wireless keyboard 10 further provides a keyboard base 11, which receives a key set 12, a central processing device 13, a wireless emitter 14, a battery 15 and an electronic sheet display 16.

The key set 12 further includes keys bearing with characters such as alphabets and numerals and special functional keys. When the keys with numerals are operated or keys with alphabets are locked as capital letters, the electronic sheet display 16 is capable of showing statuses of the keys by means of feature of the electronic sheet for facilitating the user to operate the wireless keyboard 10.

The central processing device 13 receives signals from the key set 12 and the signals are processed by the central processing device 13 before being emitted to the host unit of a computer via the wireless emitter 14. Further, the emitted signals are treated by operation and execution instructions of the host unit or the input characters are shown on the screen of the computer.

The battery 15 supplies power energy needed by the key set 12, the central processing device 13, the wireless emitter 14 and the electronic sheet display 16 while the wireless keyboard of the invention being in operation.

The electronic sheet display 16 is disposed either at the upper right side of the wireless keyboard 10 or at the upper central position of the wireless keyboard 10. The electronic sheet display 16 is capable of saving power for the wireless keyboard 10 and prolonging life span of the battery 15. The electronic sheet display 16 is made of film shaped electronic sheet device with high luminance and it is recognized easily under straight sunlight. An advantage of the electronic sheet display 16 is in that excellent power saving can be obtained because power consumption is required at the time of signal transmission only. Another advantage of the electronic sheet display 16 is in that the original display can be memorized and kept on even if power is off once key-in instructions are executed. Hence, it allows the wireless keyboard 10 almost being without increasing power consumption even if the electronic sheet display 16 is mounted to the wireless keyboard 10 additionally.

Implements of embodiments of the electronic sheet display are explained in detail hereinafter:

The first embodiment illustrated in FIG. 1 has a case plate with three light penetration apertures 111, 112, 113 standing for num lock key, caps lock key and scroll lock key. A film shaped electronic sheet display 16 is attached to the bottom of the case plate corresponding to the light penetration apertures 111, 112, 113 respectively. When the three special functional keys are touched by the user, signals caused by the touched keys to supply a driving voltage of electronic sheet via the central processing device 13 for the electronic sheet display 16 changing color and presenting the changed color via the corresponding light penetration aperture 111, 112, 113 such that status of the keys can be shown effectively. It is preferable that the adopted electronic sheet is provided with bistable image film shaped structure with functions of memory and power saving.

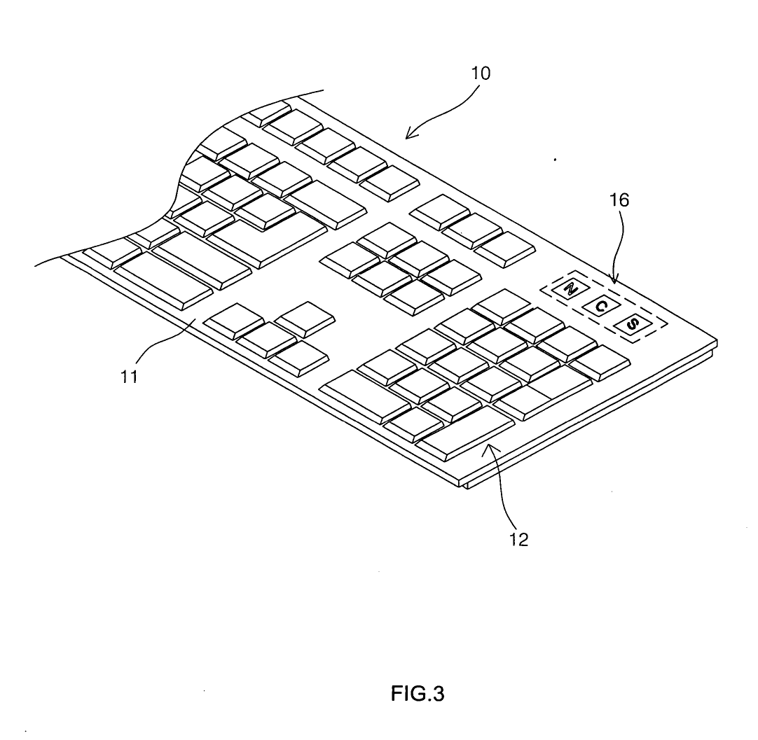

The second embodiment illustrated in FIG. 3 has the case plate thereof being carved with characters N, C and S corresponding to the num lock key, the caps lock key and the scroll lock keys respectively. An electronic sheet display 16 is attached to the bottom of the case plate corresponding to the carved characters N, C and S respectively. Once the driving voltage of the electronic sheet is induced and signal change of the corresponding key is received by the electronic sheet display 16, color light penetrating the carved letters N, C and S can be seen by the user directly to show status of the corresponding touched key.

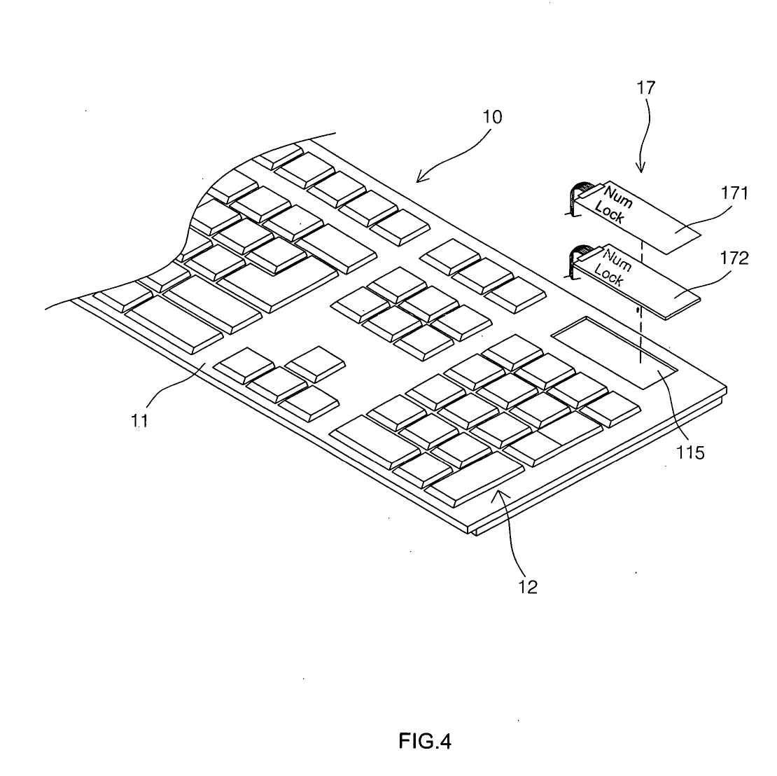

The third embodiment illustrated in FIG. 4 has the case plate thereof being provided with a recess 115 being mounted with an electronic sheet display module 17. The electronic sheet display module 17 is electrically connected to the central processing device 13 for responding signal of the touched key and receiving driving voltage. The electronic sheet display module 17 provides an electronic sheet 171 and an electrode plate 172 and the electronic sheet 171 is joined to the electrode plate 172 in a way of electrode plate 172 being attached to the bottom of the electronic sheet 171 to overlap each other. The electronic sheet 171 contains electrical particles and electrical medium liquid for corresponding to electrical field change of electrode matrix in the electrode plate 172. In this way, the electronic sheet 171 is capable of presenting default pattern or characters, that is, the letters Num Lock, Caps Lock or Scroll Lock can be shown on the electronic sheet 171 directly for standing for status of the touched keys.

As the foregoing, it is appreciated that a display for showing statuses of keys on a wireless keyboard according to the present invention has the advantage of no power consumption being required in a long period of time of status display except status transformation by means of the electronic sheet providing performance of bistable image display so that statuses of keys on the wireless keyboard can be shown and battery energy can be saved significantly.

While the invention has been described with referencing to preferred embodiments thereof, it is to be understood that modifications or variations may be easily made without departing from the spirit of this invention, which is defined by the appended claims.

What is claimed is:

1. A display for showing statuses of keys on a wireless keyboard, which provides a base, comprising:
a key set, being disposed in the base, further comprising alphabetic keys, numeral keys and special functional keys;
a central processing device, being disposed in the base, receiving signals from the key set and processing the signals;
a wireless emitter, being disposed in the base and emitting the processed signals to a host unit of a computer;
a battery, supplying required power energy for the display; and
an electronic sheet display module, providing electronic sheet, being electrically connected to the central processing device, responding to driving voltage of electronic sheet generated by the signals and resulting color change of images on the electronic sheet for showing statuses of the keys.

2. The display for showing statuses of keys on a wireless keyboard as defined in claim 1, wherein the electronic sheet provides a feature of bistable image.

3. The display for showing statuses of keys on a wireless keyboard as defined in claim 1, wherein the base has a case plate with a plurality of light penetration apertures standing for a plurality of special functional keys and the electronic sheet display module is attached to the bottom of the case plate corresponding to the light penetration apertures respectively to show status of the respective special functional keys.

4. The display for showing statuses of keys on a wireless keyboard as defined in claim 1, wherein the base has a case plate with a plurality of caved hollow characters or patterns and the electronic sheet display module is attached to the bottom of the case plate corresponding to the carved hollow characters or patterns respectively to show status of the respective special functional keys.

5. The display for showing statuses of keys on a wireless keyboard as defined in claim 1, wherein the base has a case plate providing a recess for being mounted with the electronic sheet display.

6. The display for showing statuses of keys on a wireless keyboard as defined in claim 5, wherein the electronic sheet display has an electronic sheet overlapping an electrode plate.

7. The display for showing statuses of keys on a wireless keyboard as defined in claim 6, wherein the electronic sheet contains electrical particles and electrical medium liquid to respond to electrical field change of electrode array occurring at the electrode plate for presenting default patterns or characters.

8. The display for showing statuses of keys on a wireless keyboard as defined in claim 7, wherein the default characters are Num Lock, Caps Lock and Scroll Lock for standing for statuses of the preceding keys.
